(19) United States
(12) Patent Application Publication
(10) Pub. No.: US 2023/0026834 A1
(43) Pub. Date: Jan. 26, 2023

(54) SYSTEMS AND METHODS FOR CORRELATING A NOTICE TO AIRMEN (NOTAM) WITH A CHART ON AN AVIONIC DISPLAY IN A COCKPIT OF AN AIRCRAFT

(71) Applicant: HONEYWELL INTERNATIONAL INC., Charlotte, NC (US)

(72) Inventors: Pavan Kumar Yardoni Desai, Bangalore (IN); Atmacharan Ajjavara, Bangalore (IN); Bincicil Mathew, Bangalore (IN); Dayavati Naganur, Bangalore (IN); Pooja Pai K, Bangalore (IN)

(73) Assignee: HONEYWELL INTERNATIONAL INC., Charlotte, NC (US)

(21) Appl. No.: 17/476,806

(22) Filed: Sep. 16, 2021

(30) Foreign Application Priority Data
Jul. 20, 2021 (IN) 202111032527

(51) Int. Cl. G08G 5/00; G06F 3/0484

(52) U.S. Cl. CPC G08G 5/003; G06F 3/04842

(57) ABSTRACT

Systems and methods for correlating a Notice to Airman (NOTAM) with a chart displayed on an avionic display in a cockpit of an aircraft. The method includes receiving a flight plan (FP); receiving a position and location of the aircraft; and, rendering an avionic display comprising a chart page or a NOTAM page. Responsive to receiving a NOTAM, the method determines whether the NOTAM is relevant. The NOTAM is relevant when the NOTAM is concurrently related to the FP and references a chart of a plurality of pre-loaded charts onboard the aircraft. Responsive thereto, a selectable visual indicator of the chart is rendered on the NOTAM page of the avionic display. The NOTAM is also relevant when it is related to a chart page displayed on the avionic display; responsive thereto, a selectable visual indicator of the NOTAM is rendered on the chart page displayed on the avionic display.

### CROSS REFERENCE TO RELATED APPLICATION

This application claims priority to India Provisional Patent Application No. 202111032527, filed Jul. 20, 2021, the entire content of which is incorporated by reference herein.

### TECHNICAL FIELD

The following disclosure generally relates to display systems for mobile vehicles. More particularly, the following disclosure relates to systems and methods for correlating a Notice to Airmen (NOTAM) with a chart on an avionic display in a cockpit of an aircraft.

### BACKGROUND

A NOTAM is the abbreviated name for ‘A Notice to Airmen.’ The FAA description of a NOTAM is a notice containing information (not known sufficiently in advance to publicize by other means) concerning the establishment, condition, or change in any component (facility, service, procedure of, or hazard in the National Airspace System) the timely knowledge of which is essential to personnel concerned with flight operations. Basically, a NOTAM is a notification from an official body alerting an airspace user to hazards along their route, both in the air and on the ground. This could be a closed taxiway, a notification about construction cranes or maintenance on a navigation aid.

A NOTAM that is provided for an airport is usually associated with, or references, a chart that is published for the airport, and generally contains vital information about that chart. These NOTAMs mostly refer to charts either by a chart name or a chart index number. A NOTAM can also refer to a procedure.

The Pilot who reads the NOTAM associated with a chart or a procedure may be interested in opening the referenced chart. However, a technical problem can occur when there is no direct means to open the chart referenced in the NOTAM. Instead, after reading the NOTAM, the pilot may have to memorize the chart name/chart index number, and manually select the chart on a chart screen, or in paper, by browsing through a list of charts. This increases pilot's cognitive workload.

Accordingly, improved flight display systems and methods for finding chart information based on a NOTAM are desired. Furthermore, other desirable features and characteristics of the disclosure will become apparent from the subsequent detailed description and the appended claims, taken in conjunction with the accompanying drawings, summary, technical field, and this background of the disclosure.

### BRIEF SUMMARY

This summary is provided to describe select concepts in a simplified form that are further described in the Detailed Description. This summary is not intended to identify key or essential features of the claimed subject matter, nor is it intended to be used as an aid in determining the Provided is a system for correlating a Notice to Airmen (NOTAM) with a chart on an avionic display in a cockpit of an aircraft, the system comprising: a flight management system (FMS); a position determining system; a database comprising a plurality of pre-loaded charts; a source of a NOTAM; a controller circuit operably coupled to the FMS, position determining system, database, and source of the NOTAM, the controller circuit configured by programming instructions to, receive, from the FMS, a flight plan (FP); receive, from the position determining system, a position and location of the aircraft; render the avionic display comprising a chart page or a NOTAM page; receive the NOTAM; determine that the NOTAM is relevant, when the NOTAM is concurrently related to the FP and references a chart of the plurality of pre-loaded charts, and render a selectable visual indicator of the chart on the NOTAM page of the avionic display, responsive thereto; and when the NOTAM is related to the chart page displayed on the avionic display, (i) further identify the NOTAM as relevant, and (ii) render a selectable visual indicator of the NOTAM on the chart page displayed on the avionic display, responsive thereto.

Also provided is a method for correlating a Notice to Airmen (NOTAM) with a chart on an avionic display in a cockpit of an aircraft, the method comprising: at a controller circuit, receiving, from a flight management system (FMS), a flight plan (FP); receiving, from a position determining system, a position and location of the aircraft; rendering an avionic display comprising a chart page or a NOTAM page; receiving a NOTAM; determining that the NOTAM is relevant, when the NOTAM is concurrently related to the FP and references a chart of a plurality of pre-loaded charts onboard the aircraft, and rendering a selectable visual indicator of the chart on the NOTAM page of the avionic display responsive thereto; and when the NOTAM is related to the chart page displayed on the avionic display, further identify the NOTAM as relevant, and rendering a selectable visual indicator of the NOTAM on the chart page displayed on the avionic display, responsive thereto.

Furthermore, other desirable features and characteristics of the system and method will become apparent from the subsequent detailed description and the appended claims, taken in conjunction with the accompanying drawings and the preceding background.

### BRIEF DESCRIPTION OF THE DRAWING FIGURES

At least one example of the present invention will hereinafter be described in conjunction with the following figures, wherein like numerals denote like elements, and:

FIG. 1 shows a functional block diagram of an aircraft including various systems, including a system for correlating a Notice to Airmen (NOTAM) with a chart on an avionic display in a cockpit of an aircraft, in accordance with exemplary embodiments of the present disclosure;

FIG. 2 is a flowchart illustrating a method for correlating a Notice to Airmen (NOTAM) with a chart on an avionic display in a cockpit of an aircraft, in accordance with exemplary embodiments of the present disclosure;

FIGS. 3-4 are examples of NOTAM text pages on an avionics display, in accordance with exemplary embodiments of the present disclosure; and

FIGS. 5-8 are examples of chart pages displayed on an avionics display, in accordance with exemplary embodiments of the present disclosure.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any weather or flight display system or method embodiment described herein as “exemplary” is not necessarily to be construed as preferred or advantageous over other embodiments. All the embodiments described herein are exemplary embodiments provided to enable persons skilled in the art to make or use the invention and not to limit the scope of the invention which is defined by the claims.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, programmable logic arrays, application specific integrated circuits, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

As mentioned, a NOTAM is basically a notification from an official body alerting an airspace user to hazards along their route, both in the air and on the ground. Non-limiting examples of NOTAMs include a closed taxiway, a notification about a presence of construction cranes, or a notification of maintenance on equipment, such as, a land-based navigation aid.

A NOTAM that is provided for an airport is usually associated with, or references, a chart that is published for the airport, and generally contains vital information about that chart. These NOTAMs mostly refer to charts either by a chart name or a chart index number. A NOTAM can also refer to a procedure.

The Pilot who reads the NOTAM associated with a chart or a procedure may be interested in opening the referenced chart. However, a technical problem can occur when there is no direct means to open the chart. Instead, after reading the NOTAM, the pilot must memorize the chart name or chart index number and manually select the chart on a chart screen, or in paper, by browsing through a list of charts. This increases pilot's cognitive workload.

The technical problem is further exacerbated because NOTAMs can be either real-time, and asynchronous, or known well enough in advance to be published in a NOTAM database that is uploaded into an aircraft before it begins a flight. A NOTAM that is received in real-time is often safety-related, and must be relayed to the pilots immediately, as it can include changes to routes, altitudes, speeds, obstructions, etc. (i.e., anything published on the chart to which it references).

A technical solution is disclosed herein in the form of systems and methods for correlating a Notice to Airmen (NOTAM) with a chart displayed on an avionic display in a cockpit of an aircraft. As used herein, correlate means to associate, or to cross-link (electronically) a NOTAM with the chart to which it references, such that a user interacting via the human-machine interface (HMI) can seamlessly switch from displaying one to displaying the other on an avionic display.

While the following exemplary embodiments are discussed in terms of an aircraft in flight, it should be appreciated that other embodiments may be employed in other contexts that currently rely on a regulated, periodically updated navigation database.

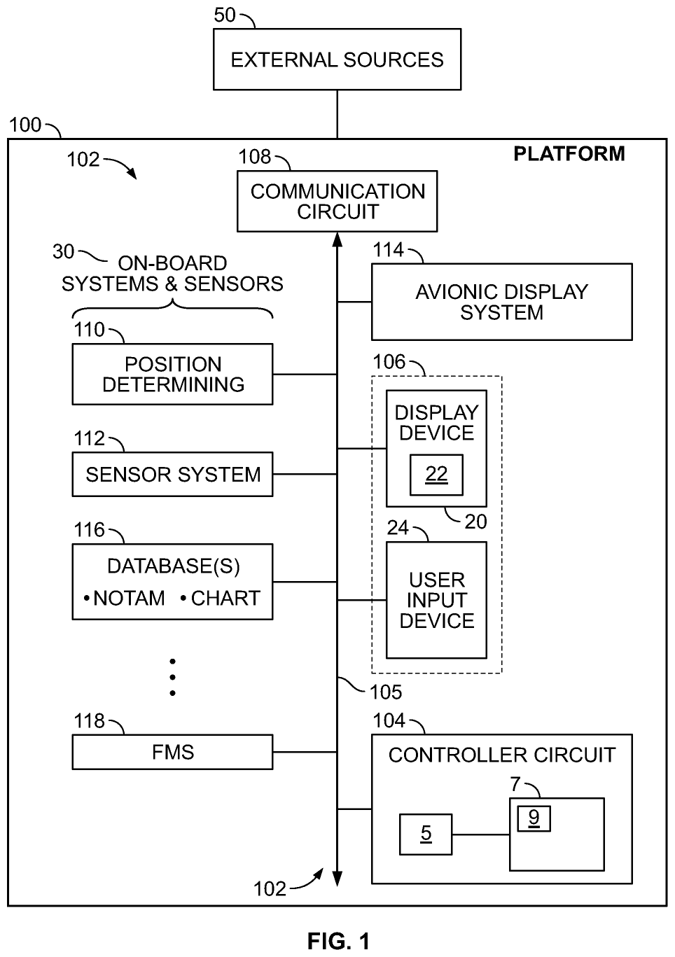

FIG. 1 is a block diagram of a system for correlating a Notice to Airmen (NOTAM) with a chart on an avionic display in a cockpit of an aircraft (shortened herein to “system” 102), in accordance with an exemplary and non-limiting embodiment of the present disclosure. The system 102 may be utilized onboard a mobile platform to provide calibration of displayed synthetic images, as described herein. In various embodiments, the mobile platform is an aircraft 100, which carries or is equipped with the system 102. Aircraft 100 may be any type of vehicle that can travel through the air (i.e., without physical contact with terrain or water). As such, aircraft 100 may be any type of airplane (regardless of size or propulsion means, ranging from large, turbine-powered commercial airplanes to small, electrically-powered drones), rotorcraft (helicopter, gyrocopter), lighter-than-air vessel (hot-air balloon, blimp), or glider, for example. Aircraft 100 may be “manned” in the conventional sense that the flight crew is present within the aircraft 100, or it may be manned remotely.

As schematically depicted in FIG. 1, system 102 includes the following components or subsystems, each of which may assume the form of a single device or multiple interconnected devices: a controller circuit 104 operationally coupled to: a HMI 106 (human-machine interface); a communications circuit 108; an avionic display system 114; and, one or more on-board systems and sensors 30. In various embodiments, the controller circuit 104 communicates with the other components of the system 102 via a communication bus 105.

The human-machine interface, HMI 106, may include a display device 20 and a user input device (UI) 24. In various embodiments, the HMI 106 includes at least one instance of an integration of the user input device 24 and a display device 20 (e.g., a touch screen display). In various embodiments, the HMI 106 may include a user input device 24 such as, any combination of a keyboard, cursor control device, voice input device, gesture input apparatus, or the like.

The avionic display system 114 is configured to receive and process information from various on-board aircraft systems, sensors (30), and databases (supplied via the communication bus 105), perform display processing and graphics processing, and to drive the display device 20 to render features in one or more avionic displays 22. The term “avionic display” is defined as synonymous with the term “aircraft-related display” and “cockpit display” and encompasses displays generated in textual, graphical, cartographical, and other formats. In various embodiments, the avionic display 22 is a primary flight display (PFD) or a navigation display. In various embodiments, the avionic display 22 can be, or include, any of various types of lateral displays and vertical situation displays on which map views and symbology, text annunciations, and other graphics pertaining to flight planning are presented for a pilot to view.

As is described in more detail below, the avionic display 22 generated and controlled by the system 102 can include graphical user interface (GUI) objects and alphanumerical input/output displays of the type commonly presented on the screens of MCDUs, as well as Control Display Units (CDUs) generally. Specifically, embodiments of the avionic display 22 include one or more two dimensional (2D) avionic displays, such as a horizontal (i.e., lateral) navigation display or vertical navigation display; and/or on one or more three dimensional (3D) avionic displays, such as a Primary Flight Display (PFD) or an exocentric 3D avionic display.

Accordingly, the display device 20 may be configured as a multi-function display (MFD) to include any number and type of image generating devices on which one or more avionic displays 22 may be produced. The display device 20 may embody a touch screen display. When the system 102 is utilized for a manned aircraft, display device 20 may be affixed to the static structure of the Aircraft cockpit as, for example, the aforementioned Head Up Display (HUD) unit, or a Head Down Display (HDD). Alternatively, display device 20 may assume the form of a movable display device (e.g., a pilot-worn display device) or a portable display device, such as an Electronic Flight Bag (EFB), a laptop, or a tablet computer carried into the Aircraft cockpit by a pilot.

In various embodiments, the HMI 106 further includes or has integrated therein an audio system capable of emitting speech and sounds, as well as of receiving speech input. In various embodiments, the HMI 106 may include any of: a graphical user interface (GUI), a speech recognition system, and a gesture recognition system. Via various display and graphics systems processes, the controller circuit 104 and avionic display system 114 may command and control the generation, by the HMI 106, of a variety of graphical user interface (GUI) objects or elements described herein, including, for example, tabs, buttons, sliders, and the like, which are used to prompt a user to interact with the human-machine interface to provide user input, and to activate respective functions and provide user feedback, responsive to received user input at the GUI object.

The on-board systems and sensors 30 generally include a position-determining system 110, a sensor system 112, one or more database(s) 116, and a flight management system (FMS) 118.

The position-determining system 110 may include a variety of sensors and performs the function of measuring and supplying various types of aircraft status data and measurements to controller circuit 104 and other aircraft systems (via the communication bus 105) during aircraft flight. In various embodiments, the aircraft status data includes, without limitation, one or more of: inertial reference system measurements providing a location, Flight Path Angle (FPA) measurements, airspeed data, groundspeed data (including groundspeed direction), vertical speed data, vertical acceleration data, altitude data, attitude data including pitch data and roll measurements, yaw data, heading information, sensed atmospheric conditions data (including wind speed and direction data), flight path data, flight track data, radar altitude data, and geometric altitude data. The position-determining system 110 may be realized as one or more of a global positioning system (GPS), inertial reference system (IRS), or a radio-based navigation system (e.g., VHF omni-directional radio range (VOR) or long-range aid to navigation (LORAN)), and it may include one or more navigational radios or other sensors suitably configured to support operation of the aircraft 100.

In some embodiments, the position-determining system 110 may also obtain and/or determine the heading of the aircraft 100 (i.e., the direction that aircraft 100 is traveling relative to some reference) using a magnet compass or a magnetometer, for example. The position-determining system 110 may also include a barometric altimeter such that the position of the aircraft 100 may be additionally determined with reference to a barometric altitude. In some embodiments, the GPS may alternatively or additionally provide altitude information as part of the position-determining system 110. As such, in an exemplary embodiment, the position-determining system 110 is capable of obtaining and/or determining the instantaneous position and altitude of the aircraft 100, and the position-determining system 110 generates aircraft status data for the aircraft, including the current location of the aircraft 100 (e.g., the latitude and longitude) and the altitude and heading of the aircraft 100. The position-determining system 110 may provide this aircraft status data to the controller circuit 104 and the flight management system (FMS) 118 to support their operation, as described herein.

The sensor system 112, as used herein, is a forward-facing sensor system mounted on the mobile platform 100, configured to obtain real-time sensor images. During aircraft operation at an airport, the sensor system 112 provides a sensor image frame depicting airport features surrounding the aircraft position and location. Non-limiting examples of the sensor system 112 include a camera, EVS Infrared, and millimeter wave system. In some embodiments, the sensor system 112 includes a camera and associated circuitry.

In various embodiments, onboard database(s) 116 may be used to store two- or three-dimensional map data, including airport features data, geographical (terrain), buildings, bridges, and other structures, street maps, including the navigational databases 116. In practice, the one or more database(s) 116 may be realized as two of two or more different onboard databases, each being a computer-readable storage media or memory. Specifically, the database(s) 116 include a chart database and a NOTAM database. The data stored in the navigation database(s) and Charts and NOTAM databases 116 may be regulated and periodically updated, as directed by a regulating entity. The chart database 116 may store a plurality of pre-loaded charts associated with the FP.

FMS 118 provides the primary navigation, flight planning, and route determination and en route guidance for the aircraft 100. The FMS 118 may contribute aircraft status data provided to controller circuit 104, such as, the aircraft's current position, attitude, orientation, and flight direction (e.g., heading, course, track, etc.), the aircraft's airspeed, ground speed, altitude (e.g., relative to sea level), pitch, and other important flight information if such information is desired. In various embodiments, FMS 118 may include any suitable position and direction determination devices that are capable of providing controller circuit 104 with at least an aircraft's current position (e.g., in latitudinal and longitudinal form), the real-time direction (heading, course, track, etc.) of the aircraft in its flight path, and other important flight information (e.g., airspeed, altitude, pitch, attitude, etc.). FMS 118 and controller circuit 104 cooperate to guide and control aircraft 100 during all phases of operation, as well as to provide other systems of aircraft 100 with flight data generated or derived from FMS 118.

The system 102 is capable of receiving NOTAMs from different sources. For example, external sources 50 includes a source of a real-time NOTAM, such as, a flight data center (FDC) and/or an air traffic control (ATC), e.g., via controller pilot data link communication (CPDLC), and may include a weather subscription service, other subscription services, a traffic monitoring service, neighbor traffic, ground stations, and the like. When a NOTAM is real-time, it may contain vital information about changes/updates in charts which may not be present in the plurality of pre-loaded charts stored in the chart database, which is generally loaded on the Aircraft prior to operation. NOTAMs generally contain a Chart Name/Index along with related chart information.

It should be appreciated that aircraft 100 includes many more additional features (systems, databases, etc.) than the illustrated systems 106-118. For purposes of simplicity of illustration and discussion, however, the illustrated aircraft 100 omits these additional features.

The term “controller circuit,” as appearing herein, broadly encompasses those components utilized to carry-out or otherwise support the processing functionalities of the system 102. Accordingly, in various embodiments, the controller circuit 104 can be implemented as a programmable logic array, application specific integrated circuit, system on a chip (SOC), or other similar firmware, as well as by a combination of any number of dedicated or shared processors, flight control computers, navigational equipment pieces, computer-readable storage devices (including or in addition to memory 7), power supplies, storage devices, interface cards, and other standardized components.

In various embodiments, as depicted in FIG. 1, the controller circuit 104 is realized as an enhanced computer system, having one or more processors 5 operationally coupled to computer-readable storage media or memory 7, having stored therein at least one novel firmware or software program (generally, computer-readable instructions that embody an algorithm) for carrying-out the various process tasks, calculations, and control/display functions described herein. The memory 7, may include volatile and nonvolatile storage in read-only memory (ROM), random-access memory (RAM), and keep-alive memory (KAM), for example. KAM is a persistent or non-volatile memory that may be used to store various operating variables while the processor 5 is powered down. The memory 7 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the processor 5.

During operation, the controller circuit 104, and hence the processor 5, may be programmed with and execute the at least one firmware or software program (for example, program 9, described in more detail below) that embodies an algorithm for receiving, processing, enabling, generating, updating and rendering, described herein, to thereby perform the various process steps, tasks, calculations, and control/display functions described herein.

Controller circuit 104 may exchange data, including real-time wireless data, with one or more external sources 50 to support operation of the system 102 in embodiments. In this case, the controller circuit 104 may utilize the communication bus 105 and communications circuit 108.

In various embodiments, the communications circuit 108 includes the hardware and software to support one or more communication protocols for wireless communication between the processor 5 and external sources, such as satellites, the cloud, communication towers and ground stations. In various embodiments, the communications circuit 108 supports wireless data exchange over a communications network, such as a public or private network implemented in accordance with Transmission Control Protocol/Internet Protocol architectures or other conventional protocol standards. Encryption and mutual authentication techniques may be applied, as appropriate, to ensure data security. In various embodiments, the communications circuit 108 supports communication with technicians, and/or one or more storage interfaces for direct connection to storage apparatuses. In various embodiments, the communications circuit 108 is integrated within the controller circuit 104.

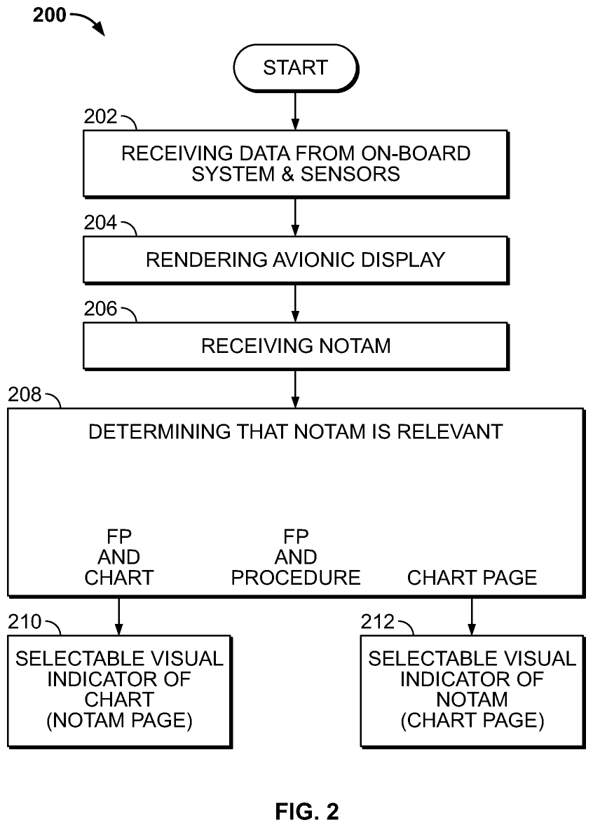

Turning now to FIG. 2, and with continued reference to FIG. 1, a flowchart of a method 200 for correlating a Notice to Airmen (NOTAM) with a chart displayed on an avionic display in a cockpit of an aircraft is described, in accordance with exemplary embodiments of the present disclosure. For illustrative purposes, the following description of method 200 may refer to elements mentioned above in connection with FIG. 1, for example, the tasks/operations may be performed by the controller circuit 104. In practice, portions of method 200 may be performed by different components of the described system. It should be appreciated that method 200 may include any number of additional or alternative tasks, the tasks shown in FIG. 6 need not be performed in the illustrated order, and method 200 may be incorporated into a more comprehensive procedure or method having additional functionality not described in detail herein. Moreover, one or more of the tasks shown in FIG. 6 could be omitted from an embodiment of the method 200 as long as the intended overall functionality remains intact.

At 202, the system 102 is receiving data from various on-board systems and sensors 30. Received data at 202 includes a flight plan (FP). At 202, the system 102 is assumed to have received pre-loaded charts for the trip associated with the FP and required updates to databases 116 and may also be receiving data from external sources 50.

At 204, the system is rendering an avionic display 22, as described above. The system is rendering an avionic display 22 comprising a chart page or a NOTAM page. This is a logical “or”, which means not only that, in various embodiments, at 204 the system 102 is rendering the avionic display 22 comprising either a chart page or a NOTAM page, but that in other embodiments, at 204, the system 102 is rendering the avionic display 22 comprising both a chart page and a NOTAM page, e.g., as two distinct windows on a MFD.

At 206, the system receives a NOTAM. In various embodiments, the received NOTAM is real-time, received via an external source 50. In various embodiments, the received NOTAM is from a pre-loaded NOTAM storage.

At 208, the system 102 processes the NOTAM to determine whether it is “relevant.” In various embodiments, to determine relevance, the NOTAM messages are parsed by the system 102 to identify the Chart Name/Index and then the system 102 uses the parsed information to find to the corresponding chart in the chart database.

In an embodiment, determining relevance includes parsing the NOTAM to identify at least one chart referenced in the NOTAM, and then comparing the NOTAM referenced chart to either the FP or a currently displayed chart page on the avionic display. In various embodiments, the system 102 identifies the NOTAM as relevant when the NOTAM is related to the FP and references a chart of the plurality of pre-loaded charts used in the FP.

In various embodiments, the system 102 identifies the NOTAM as relevant when the NOTAM is concurrently related to the FP and references procedures embodied in the FP (i.e., it will affect the FP procedurally). Accordingly, in various embodiments, determining that the NOTAM is relevant to the FP is a function of either a chart that is referenced in the NOTAM, or a procedure referenced in the NOTAM.

At 208, in various embodiment, the system 102 further identifies the NOTAM as relevant when a chart page is displayed on the avionic display, and the NOTAM is related to the chart displayed on the chart page of the avionic display.

With this methodology, at 208, the system 102 establishes a two-way correlation between NOTAMs and Charts. This will help the Pilot to easily open a Chart from a NOTAM and vice-versa.

Moving into 210 and 212, the system 102 renders a selectable visual indicator about the NOTAM for the pilot, and the form of the visual indicator is related to the page or window currently displayed on the avionic display. For example, at 210, when the pilot is displaying a NOTAM page, which is usually alphanumeric, the system renders a selectable visual indicator of the chart referenced on the NOTAM page; this indicates that the real-time NOTAM or the NOTAM retrieved from the pre-loaded database is relevant and what chart or procedure it references. In some embodiments, the selectable visual indicator of the chart referenced is rendered as an underline or hyperlink of text naming the referenced chart. In another example, at 210, the system 102 is configured to render the selectable visual indicator of the chart referenced as a highlight or color change of text naming the referenced chart.

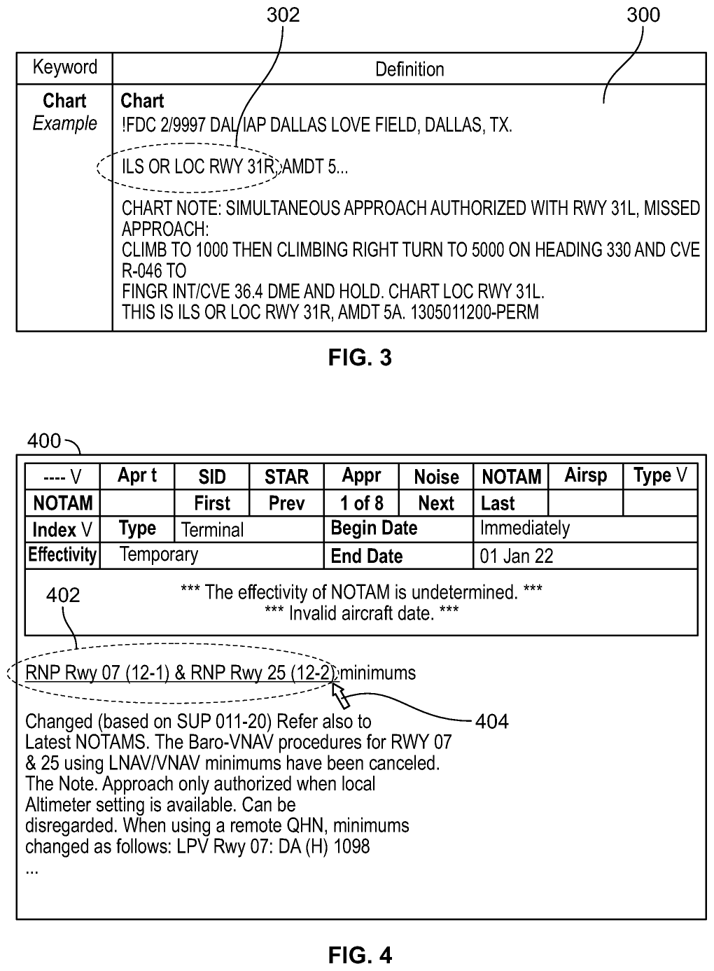

In some embodiments, hovering a cursor over the selectable visual indicator may change the cursor appearance (e.g., from an arrow to a pointing hand). Selecting the selectable visual indicator will open a chart page, the open chart page being the chart referenced in the NOTAM. FIGS. 3 and 4 illustrate how the system 102 may visually distinguish the chart referenced in the NOTAM from other text in the NOTAM.

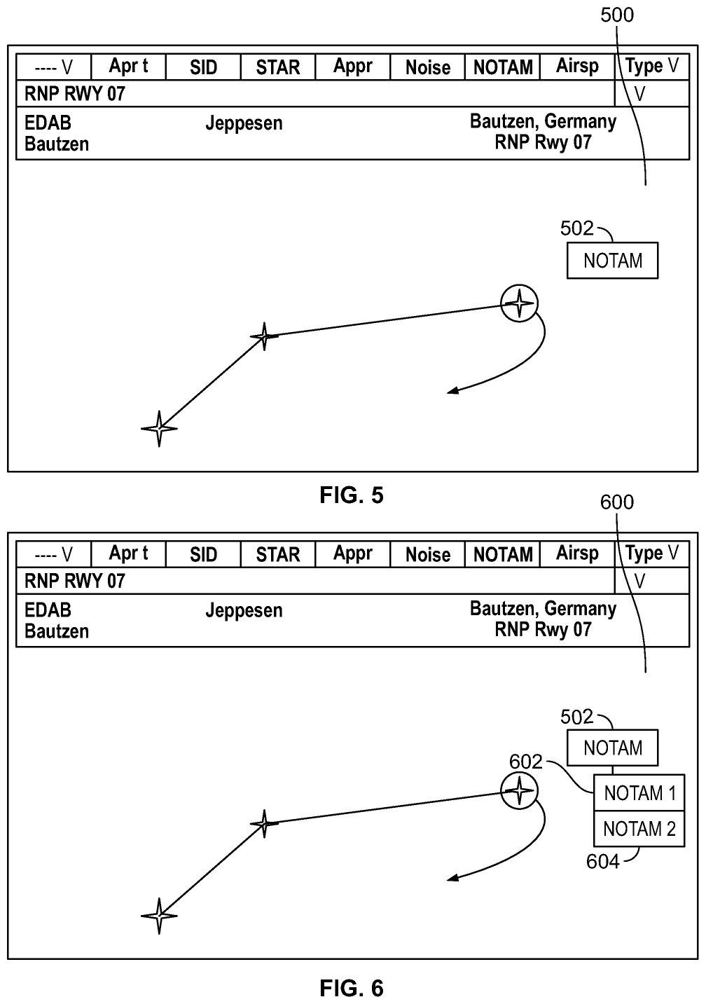

At 212, when the pilot is displaying a chart page, the system 102 renders a selectable visual indicator of the NOTAM when both the NOTAM is relevant, and the chart page is rendered on the avionic display. In some embodiments, the selectable visual indicator of the NOTAM is a pop-up alphanumeric message comprising information from the real-time NOTAM or the one retrieved from the pre-loaded database. In other embodiments, the selectable visual indicator of the NOTAM is a pop-up selectable graphical user interface (GUI) object prompting user attention to the NOTAM. FIGS. 5-8 illustrate various GUI objects overlaid on a chart page, responsive to information in the NOTAM. After 210 or 212, the system 102 may cycle back to 206 or end.

An example of a flight data center (FDC) NOTAM text page of an avionic display is shown in FIG. 3 (NOTAM page 300). Encircled at 302 is a reference to a chart name, “ILS OR LOC RWY 31R, AMDT5 . . . ” thus, this FDC NOTAM page includes the chart name. In FIG. 4, a class II NOTAM is depicted (NOTAM page 400), showing a chart name and chart index, encircled at 402. Additionally, FIG. 4 depicts rendering a selectable visual indicator to distinguish the chart: the chart name and index 402 are rendered underlined, as may be in practice a hypertext link. Additionally, a cursor, 404 is shown. The cursor 404 can be hovered over the chart name and index 402 to select it.

FIGS. 5-8 are illustrations showing various selectable visual indicators of the real-time NOTAM on the chart page. In FIG. 5, chart page 500 is displayed on the avionic display 22. When the system 102 determines that the NOTAM is relevant, it renders the selectable visual indicator of the real-time NOTAM or the one retrieved from the pre-loaded database 502. In the example, the selectable visual indicator of the real-time NOTAM 502 on the chart page as a pop-up graphical user interface (GUI) object with the text “NOTAM,” prompting user attention to the NOTAM.

FIG. 6 provides an example of when the system 102 identifies two relevant NOTAMs, NOTAM 1, and NOTAM 2. The chart page 600 again has the selectable visual GUI indicator of the real-time NOTAM or the one retrieved from the pre-loaded database 502, and responsive to receiving a user selection of “NOTAM” 502, the system 102 renders a pop-up graphical user interface (GUI) object with the text “NOTAM 1” 602, and a pop-up graphical user interface (GUI) object with the text “NOTAM 2” 604, prompting user attention to the presence of two relevant NOTAMs to the chart displayed on the chart page 600.

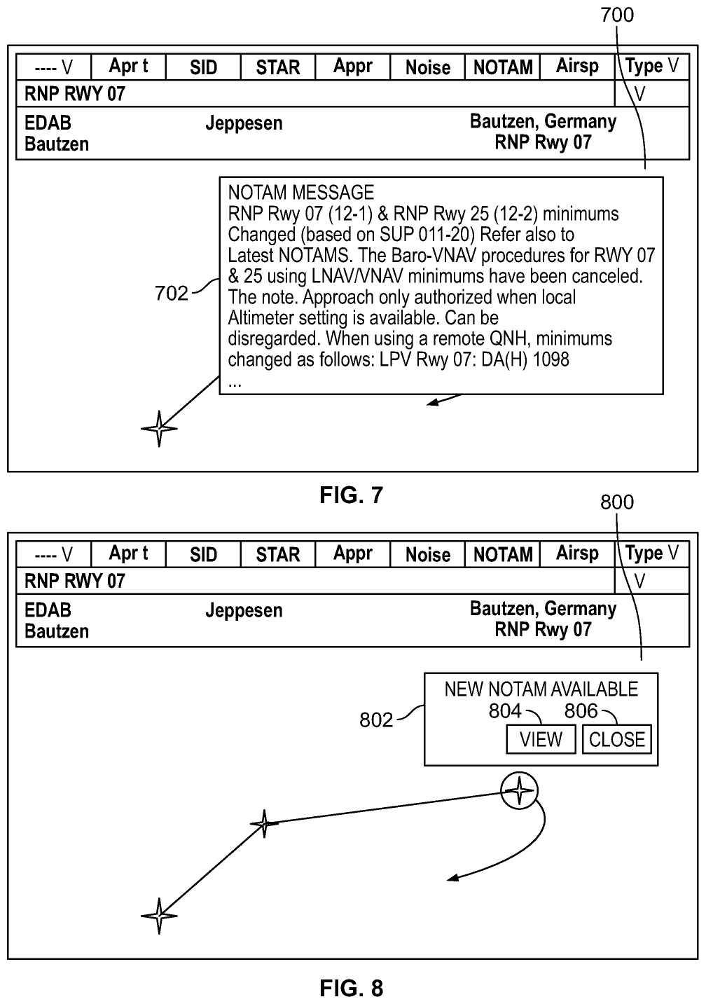

FIG. 7 provides an example of a system 102 response to the user selecting a NOTAM GUI object, e.g. selecting NOTAM 1 or NOTAM 2 in FIG. 6 or selecting NOTAM in FIG. 5. Responsive to receiving a user selection of the NOTAM GUI object, the system 102 renders the text contents of the NOTAM (text block 702).

FIG. 8 provides an example of what the system 102 may display for the pilot when a new NOTAM comes in and is identified as relevant after the pilot has been viewing a chart on the chart page 800 for a while. In this example, the system 102 may render a pop-up graphical user interface (GUI) object 802, e.g., with the text “NEW NOTAM AVAILABLE,” and that GUI object 802 may further have a selectable “view” button 804 and a selectable “close” button 806. Responsive to receiving a user selection of “view,” the system may open the text of the new NOTAM, as shown in 702. Responsive to receiving a user selection of “close,” the system 102 may close the GUI object 802.

Accordingly, the present disclosure has provided several embodiments of systems and methods for correlating a Notice to Airmen (NOTAM) with a chart on an avionic display in a cockpit of an aircraft. Provided embodiments correlate or cross-reference a NOTAM with a chart referenced in the NOTAM. With this methodology, at 208, the system 102 establishes a two-way correlation between NOTAMs and Charts. This will help the Pilot to easily open a Chart from a NOTAM and vice-versa. The renderings of the selectable indicators for a chart and/or for an associated NOTAM decrease cognitive load and provide an objectively improved HMI over available display systems.

Although an exemplary embodiment of the present disclosure has been described above in the context of a fully-functioning computer system (e.g., system 102 described above in conjunction with FIG. 1), those skilled in the art will recognize that the mechanisms of the present disclosure are capable of being distributed as a program product (e.g., an Internet-disseminated program 9 or software application) and, further, that the present teachings apply to the program product regardless of the particular type of computer-readable media (e.g., hard drive, memory card, optical disc, etc.) employed to carry-out its distribution.

Terms such as “comprise,” “include,” “have,” and variations thereof are utilized herein to denote non-exclusive inclusions. Such terms may thus be utilized in describing processes, articles, apparatuses, and the like that include one or more named steps or elements but may further include additional unnamed steps or elements.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A system for correlating a Notice to Airmen (NOTAM) with a chart on an avionic display in a cockpit of an aircraft, the system comprising:
a flight management system (FMS);
a position determining system;
a database comprising a plurality of pre-loaded charts;
a source of a NOTAM;
a controller circuit operably coupled to the FMS, position determining system, database, and source of the NOTAM, the controller circuit configured by programming instructions to,
receive, from the FMS, a flight plan (FP);
receive, from the position determining system, a position and location of the aircraft;
render the avionic display comprising a chart page or a NOTAM page;
receive the NOTAM;
determine that the NOTAM is relevant, when the NOTAM is concurrently related to the FP and references a chart of the plurality of pre-loaded charts, and render a selectable visual indicator of the chart on the NOTAM page of the avionic display, responsive thereto; and
when the NOTAM is related to the chart page displayed on the avionic display, (i) further identify the NOTAM as relevant, and (ii) render a selectable visual indicator of the NOTAM on the chart page displayed on the avionic display, responsive thereto.

2. The system of claim 1, wherein the controller circuit is further configured to generate the selectable visual indicator of the chart on the NOTAM page as an underline or hyperlink of text naming the referenced chart.

3. The system of claim 1, wherein the controller circuit is further configured to generate the selectable visual indicator of the chart on the NOTAM page as a highlight or color change of text naming the referenced chart.

4. The system of claim 1, wherein the controller circuit is further configured to generate the selectable visual indicator of the NOTAM on the chart page as a pop-up alphanumeric message comprising information from the NOTAM.

5. The system of claim 1, wherein the controller circuit is further configured to generate the selectable visual indicator of the NOTAM on the chart page as a pop-up graphical user interface (GUI) object prompting user attention to the NOTAM.

6. The system of claim 1, wherein the controller circuit is further configured to identify that the NOTAM is relevant by parsing text of the NOTAM into a chart name or chart index.

7. The system of claim 1, wherein the source of the NOTAM is a pre-loaded database.

8. The system of claim 1, wherein the NOTAM is a real-time notification.

9. The system of claim 1, wherein the FMS further provides a procedure, and wherein the controller circuit is further configured to:
determine that the NOTAM is relevant, when the NOTAM is concurrently related to the FP and references the procedure; and
render a selectable visual indicator of the procedure on the NOTAM page of the avionic display.

10. The system of claim 1, wherein each chart of the plurality of charts is for one or more of: Airport Diagrams, Departure, Arrival, Approach, Airspace, and Noise abatement.

11. A method for correlating a Notice to Airmen (NOTAM) with a chart on an avionic display in a cockpit of an aircraft, the method comprising:
at a controller circuit,
receiving, from a flight management system (FMS), a flight plan (FP);
receiving, from a position determining system, a position and location of the aircraft;
rendering an avionic display comprising a chart page or a NOTAM page;
receiving a NOTAM;
determining that the NOTAM is relevant, when the NOTAM is concurrently related to the FP and references a chart of a plurality of pre-loaded charts onboard the aircraft, and rendering a selectable visual indicator of the chart on the NOTAM page of the avionic display responsive thereto; and
when the NOTAM is related to the chart page displayed on the avionic display, further identify the NOTAM as relevant, and rendering a selectable visual indicator of the NOTAM on the chart page displayed on the avionic display, responsive thereto.

12. The method of claim 11, further comprising rendering the selectable visual indicator of the chart on the NOTAM page as an underline or hyperlink of text naming the referenced chart.

13. The method of claim 11, further comprising rendering the selectable visual indicator of the chart on the NOTAM page as a highlight or color change of text naming the referenced chart.

14. The method of claim 11, further comprising rendering the selectable visual indicator of the NOTAM on the chart page as a pop-up alphanumeric message comprising information from the NOTAM.

15. The method of claim 11, further comprising rendering the selectable visual indicator of the NOTAM on the chart page as a pop-up graphical user interface (GUI) object prompting user attention to the NOTAM.

16. The method of claim 11, further comprising identifying that the NOTAM is relevant by parsing text of the NOTAM into a chart name or chart index.

17. The method of claim 11, wherein receiving the NOTAM comprises receiving a pre-loaded NOTAM from an on-board database.

18. The method of claim 11, wherein receiving the NOTAM comprises receiving a real-time NOTAM from an external source.

19. The method of claim 11, further comprising:
determining that the NOTAM is relevant, when the NOTAM references a procedure that is related to the FP; and
rendering a selectable visual indicator of the procedure on the NOTAM page of the avionic display.

20. The method of claim 11, wherein each chart of the plurality of pre-loaded charts is for one or more of: Airport Diagrams, Departure, Arrival, Approach, Airspace, and Noise abatement.
